(19) United States
(12) Patent Application Publication
(10) Pub. No.: US 2014/0244389 A1
(43) Pub. Date: Aug. 28, 2014

(54) SYSTEM AND METHOD FOR CLOUD BASED PAYMENT INTELLIGENCE

(71) Applicant: CLOUT CORPORATION, Beverly Hills, CA (US)

(72) Inventor: Francis Konig, Beverly Hills, CA (US)

(73) Assignee: CLOUT CORPORATION, Beverly Hills, CA (US)

(21) Appl. No.: 14/192,836

(22) Filed: Feb. 27, 2014

Related U.S. Application Data
(60) Provisional application No. 61/770,217, filed on Feb. 27, 2013.
(60) Provisional application No. 61/944,972, filed on Feb. 26, 2014.

(51) Int. Cl. G06Q 30/02

(52) U.S. Cl. CPC G06Q 30/0255
USPC 705/14.53

(57) ABSTRACT

The present application provides a system and method that includes receiving first and second electronic information associated with a first and second entity. The information is filtered and quantified and, thereafter qualified using at least one processor. Moreover, information associated with at least one reward and/or advertisement is determined to be provided to at least one of the first and second entities in accordance with the qualifying. The information associated with the at least one reward and/or advertisement is transmitted to at least one computing device.

### CROSS-REFERENCE TO RELATED APPLICATION

This application claims the benefit of U.S. provisional patent application Ser. No. U.S. 61/770,217, filed on Feb. 27, 2013 and entitled, “SYSTEM AND METHOD FOR CLOUD BASED PAYMENT INTELLIGENCE,” and further to U.S. provisional patent application Ser. No. U.S. 61/944,972 filed on Feb. 26, 2014 and entitled, “SYSTEM AND METHOD FOR CLOUD BASED PAYMENT INTELLIGENCE,” the entire contents of all of which are incorporated by reference as if set forth herein in their respective entireties.

### BACKGROUND OF INVENTION

I. Field of the Invention

The disclosure generally relates to the financial and marketing industries and in particular, it relates to ranking, and scoring, the activity and ability of entities in a network of entities, and determining a reward and/or advertisement.

II. Background Art

As the world is getting more connected, the actions of an individual or business are normally noticed and replicated or attempted by peers and observers. This ability to influence others' spending, activity, opinion and preferences is highly desirable to businesses as it leads to increased sales due to introduction of new customers and/or customer loyalty accruing from alignment of preferences and interests. The influence is normally measured in spending capacity as well as ability to reach a larger than normal number of people willing to listen, read or watch an individual or business' communication or behavior.

Understanding and accurately estimating the activity and ability of a customer (individual or another business) has been a challenge for a number of businesses. This gets harder for small businesses without market research departments or large advertising budgets to spread out and reach a bigger part of their target market, not mentioning expensive trial and error approaches. Making matters worse, access to current and potential consumers' confidential information is heavily shunned because of the infringement on privacy and illegality of some access methods. The color or type of a person's credit card or, where possible, obtaining a person's cash balance, credit balance, or Fair Isaac Corporation (FICO) score does not provide businesses with enough information to understand how likely that person is to purchase their products or services. Measurement of the person's historical spending at a single merchant usually does not provide enough data-points to understand a customer's spending preferences outside that merchant's business, or their influence on their friends' expenditure habits. Attempts by previous inventions at predicting a customer's spending ability by assigning a single non-evolving score based on a user's transactions leaves a lot of room for inaccuracies.

Accordingly, there is not a method and apparatus for accurately and continually estimating a consumer's activity and ability—beyond spending, assign a score to it and update it based on their activity and other related non-activity information, while presenting it in a simple, easy to understand and usable format to interested and approved parties without compromising the owner's sensitive personal information.

### SUMMARY

In one or more implementations, the present application provides a system and method that includes accessing, by at least one processor, at least one database that includes electronic entity information including information associated with each of a plurality of respective entities. Moreover, electronic filter information representing at least one parameter for filtering information in accordance with relevance of information and electronic weighting information representing at least one parameter usable for quantifying filtered information can be included in the database(s). Further, first electronic information associated with a first of the respective entities is received, using the at least one processor, over a data communication network. The information is filtered in accordance with the electronic filtering information, and the filtered information is quantified in accordance with the electronic weighting information.

Continuing with reference to the one or more implementations, second electronic information associated with a second of the respective entities is received, using the at least one processor, over a data communication network. The information is also filtered in accordance with the electronic filtering information, and the filtered information is quantified in accordance with the electronic weighting information. Thereafter, the quantified filtered first and second electronic information is qualified using the at least one processor, and information associated with at least one reward and/or advertisement is determined to be provided to at least one of the first and second entities in accordance with the qualifying. The information associated with the at least one reward and/or advertisement is transmitted to at least one computing device.

These and other aspects, features, and advantages can be appreciated from the accompanying description of certain embodiments of the invention and the accompanying drawing figures and claims.

### BRIEF DESCRIPTION OF DRAWINGS/FIGURES

Further aspects of the present disclosure will be more readily appreciated upon review of the detailed description of its various embodiments, described below, when taken in conjunction with the accompanying drawings, of which:

FIG. 1 is a block diagram showing an overview for generating a user's score the first time;

FIG. 2 is a diagram showing the process of continuous adjustment of a user's score based on affecting factors;

FIG. 3 shows an example of user categorization according to their scores;

FIG. 4 is a diagram illustrating the referral network relationship between users;

FIG. 5 is an illustration of an example of an approach to rewarding users in the network (using signup commissions and cash back rewards);

FIG. 6 is a diagram showing an example of a reward scheme for signup commissions;

FIG. 7 is an overview diagram for generating a System Score;

FIG. 8 is a schematic diagram of the system—which embodies the computerized part of the network;

FIG. 9 is a diagram is provided illustrating an example hardware arrangement in accordance with an example implementation of the present application;

FIG. 10 illustrates functional elements of an example information processor and/or user workstation in accordance with an example implementation; and

FIG. 11 is a flowchart illustrating steps associated with an example implementation of the present application.

### DETAILED DESCRIPTION

### Overview

Specific configurations and arrangements are discussed for illustrative purposes only. A person skilled in pertinent art will recognize that other configurations and arrangements can be used without departing from the spirit and scope of the present invention. Also, it will be apparent to a person skilled in pertinent art that this invention can also be employed in a variety of other applications and industries.

As used herein, the terms “entity”, “consumer”, “user”, “member” and/or their plural form can be used interchangeably and refer, generally, to an individual, software, system, or business that is part of and uniquely recognized as an actor in a social/economic and/or data communication network, such as shown and described herein. The entity is capable of accessing, using, being affected by or benefiting from the system that the present application entails.

In addition, the terms “business”, “merchant” or “store” may be used interchangeably and refer, generally to any entity, person, distributor system, software and/or hardware that can be a provider, broker, advertiser, and/or any other entity in a distribution chain of goods or services. For example a merchant may be a car dealer, a travel agency, a healthcare service provider, an online merchant or the like.

Also as used herein, the term, “score,” as in “System Score” (also, in one or more implementations, referred to herein as a “Clout Score”), “Store Score” or “Merchant Score” is used to refer, generally, to a value (e.g., a number) to represent at least one of performance and/or rank of an entity in the system. A score may be influenced, for example, as a function of activity and/or ability (such as ability to influence other entities) of an entity in the network of other entities supported by the system described herein.

Further, the term “referral” refers, generally, to an invitee of an active user on the Clout network who accepts their invitation and joins the network.

Further, the terms “system”, “platform” and “network” may also be used interchangeably and refer, generally, to a collection of the system, one or more of its components, actors and administrators that the present application embodies. In one or more particular contexts, a “system” can also refer to an entity.

### I. How a Score is Obtained

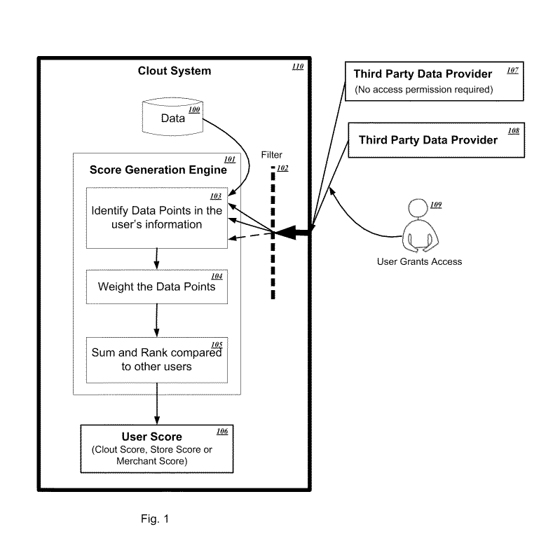

In accordance with the present application, a score can be generated by collecting, filtering, categorizing, weighting, tracking, and measuring data about an entity and that can be received from sources authorized or provided by a user as well as one or more public and/or private sources. Referring to the example shown in FIG. 1, information can be collected in various ways. Example ways that information can be collected include, but are not limited to:

1) Purchasing data from third party data providers. In this example, data can originate from a database, or can be obtained via data access through a pre-established process, such as a third-party API query, cron job or manual data transmission. Such data may include transaction information, user location or additional information about a user, among others.

2) The user providing access to their data domiciled at a third-party system. User consent and/or user log-in at the third party system can be required to confirm identity. Such data can include the user's personal information, contacts, bank accounts, or financial transactions.

3) Scraping data from public data sources. In one or more embodiments of the present application, public data sources can include online public libraries, government census data, and telephone directories. Examples of data obtained from these sources can include business information and contacts, general population data about a geographical area, and trends in consumer preferences.

4) Data submitted by the user or automatically collected by a system from the user. In this example, data can include check-in location information, survey submissions, system activity tracking information, and third party computer system data submitted about a user's activities, such as from a point of sale.

Data can be filtered to remove information not relevant to the scoring process and therefore would be an extra processing burden. Information that may be removed can include non-relevant details of the purchased items at a store, color preferences, an individual's healthcare information, an individual's phone numbers, an individual's email addresses, an individual's name, an individual's address, and the user's family information.

The filtered data is passed on to the categorization processes which organize the data such that the data can be used faster and/or more easily. For example, businesses can be sorted by Standard Industrial Classification (SIC) codes such that related businesses can be compared to their peers. In one or more embodiments in accordance with the present application, individual users can be sorted by location such that the system can easily and quickly provide appropriate information to the user or compare the user with others in the same area for a more reasonable score.

Tracking the user's activity can be achieved through the system data collection capabilities and participation of third-party data providers. In the system, the user's actions (e.g., logging in, linking their credit card(s) to the system, opting-in to receive promotions and/or advertisements, answering surveys, or inviting the user's contacts) can be recorded and their performance evaluated and stored in the tracking database for future reference. From third-party providers, off-line relevant activities can be tracked and reported to the system such that the user can receive extra consideration during generation of their scores. Such off-line activities can include off-line cash purchases, participation in a merchant user's promotion, or fundraising drives, and promoting the system to friends outside of the network.

In accordance with the present application, a data point can be measured by first determining the data point's type. For example, the type can be a Boolean value (e.g., has the user connected a social network? YES/NO), a number (e.g., how many friends did the user refer last month? 893 OR how much did the user earn in cash back in the last 180 days? $1,285.50), a text (e.g., what is the user's address? 123 Example Street, New York, N.Y. 14032), a list of numbers (e.g., what are the last five purchase amounts by the user? $23.80, $10.00, $59.50, $3.50, $9.99), or an image (e.g., does the user have a current photo? https://www.clout.com/images/C123902123.jpg). Based on the type, the expected value for the data point can be determined. The data point value can then be computed or retrieved by the system processes, and prepared for use by the user/system that requests it.

To join the network, an entity or its representative provides identifying information and may be required to provide proof of validity where applicable. Proof of validity can include but is not limited to the entity's name, address, contact information, and referring entity.

In addition, credentials to other third party sources of information can be required to fill in the information gaps in the entity's profile, which may include connecting financial accounts to the system. The credentials can include the third party source's user name and password as well as other personally identifying information to prove their identity. Except where communicated, credentials to third party sources are usually not stored or used by the system for other purposes. Data obtained from third party sources can include the user's contacts, transaction history, device usage, service or product preferences, and identifying or classification information.

Referring to the example shown in FIG. 1, data collected about the user is organized and filtered for information 102 relevant to the system. Examples of relevant data-points include whether a user completed their profile, adding other users to the referral network, tracking of bank spending history, bank account activity, store purchases, and whether the user redeemed and/or responded to promos and/or advertisements.

The filtered information can be weighted based on level of importance to the network, the other users, and the user's profile 104. In the data collected about the user, data points (parameters) are identified which can be used to compare the performance of the user versus others in the network. Example performance parameters can include amount, quality, age, accuracy, or ease of obtaining the data. In one or more implementations, data points are weighted in accordance providing one or more fair scores, such as without a consideration of one or more of the user's attributes, such as age, gender, race, national origin, or name.

In one implementation, information, quantified information, rank, and/or score can be used to determine the price of delivering advertising and/or promotions to an entity or entities. In another implementation, information, quantified information, rank, and/or score can be used to determine the price of products or services offered to and/or consumed by an entity. In another implementation, information, quantified information, rank, and/or score can be used to determine if, when, how, and/or how much certain terms and/or conditions and/or price and/or compensation should be modified by an entity and/or for an entity.

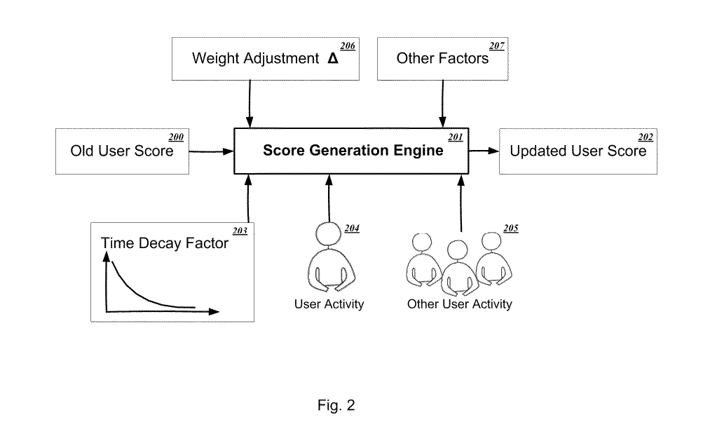

Assigning a score to a data point for a given user can be done by designating a weight to the data point based on its rank among other users under consideration. A minimum and maximum score can be attached to each data point to normalize the results and give a fair consideration to all members. Referring to the example in FIG. 2, the total score 202 can be obtained by summing the adjusted weights and ranking them in relation to other users. In one or more embodiments of the present application, the score generation engine 201 can be used to rank and compare one user to the other users in the system (with the scoring based on factors that are important for the system). In one or more embodiments of the present application, the score can be used to rank and compare one user to the other users as those users relate to an entity in the system (with the scoring based on factors that are important for the entity). Using this technique, each user can have a score for the overall system, and a separate score for each entity in the system which is unique to that entity; when this approach is applied between entities whereby one of the entities is a merchant, the score is referred to as the “Store Score.” A user's Store Score can vary substantially from one entity to another depending on a user's activity 204 compared to activity of other users 205 for each of the data-points of interest, other factors 207 being measured for each such entity, and the weighting of such data-points 206, and taking into account the time decay factor 203.

A user's score can rise or fall based on that user's activity 204. If the user is inactive for longer than a data point's period of relevance, the data point can start to decay 203. In other words, a user's score that was previously high can fall if there is no activity from the user in relation to the system. For example, if a previously, highly-active user (with a high score) loses his or her financial resources and cannot spend as before, he or she may not retain the high score based on their previous status. A user's Clout Score and respective Store Score adjust accordingly to reflect their current status such that businesses are not misinformed about the user's spending ability. In another example in accordance with the present application, if a business that used to sign up a number of its clients to the network suddenly stops or reduces its rate of sign up by changing or modifying their business policies, their Merchant Score adjusts accordingly. This ensures that their privileges and rewards are also updated to reflect their new policy.

Additionally, in one or more embodiments of the present application, if a user participates in or originates an activity that violates network policies, the user can be blocked from future access to the system or punished by lowering their score by a predetermined or weighted amount. A note can also be tagged to their record such that other members of the network that are interested in dealing with them are aware of the fact beforehand. Such activities can include cheating or defrauding the system or an entity in the system, breaches of system terms and conditions, un-authorized access to any network data or other non-public sections, cyber-bullying other users on the system, sending unauthorized messages or spam, defacing other user's profiles—even if the other user provided them access, or any other activities that make a user a nuisance to other users, the network administrators or the system itself.

Furthermore, a score can be modified due to an update to the weight of a given data point 206. This weight can be adjusted by an authorized user such as the network administrator, a merchant store manager (for a Store Score) or the system itself (based on a statistical analysis). This modification is continuous to ensure a more accurate computation of a user's influence. For example if, after a statistical analysis, it is observed that when comparing users who otherwise spend the same amount of money on average and whose spending is concentrated in one particular sector (e.g., travel and entertainment) verses another sector (e.g., automobiles), they are more likely to spend a larger portion of their disposable income, or are more likely to respond to promotions, or have a higher influence over their counterparts, then the weighted value of the data point for travel and entertainment spending may be increased to better reflect the value of the users. The Store Score for the respective users who are affected by this modification may increase, for example, based on weighting of these factors with respect to merchants who are classified in the applicable category.

Activity of the other users in the network 205 can also affect a user's score. A reduction or increase in their activity in relation to the user's activity can raise or lower the user's score, respectively. This is because, in one or more implementations, the score may involve a rank aspect and those who are more active (e.g., respond to more promotions, spend more, have a higher account balance, or refer more of their friends to the network) receive an increase in their score. In contrast, the score of a dormant user can start to fall when adjusted for rank of the activity results (e.g., dormant user responds to fewer promotions, spends less, has a lower account balance, or refers fewer friends to join the system).

Also, unless specified otherwise, most data points awarded have an expiry date or decay factor 203. To maintain the points awarded, the user continues participating in an activity related to the data point. For example, if 50 points are awarded for a check-in at a business during the last 7 days and the user does not check-in by the 7th day, their previous 50 points for this data point start to decay on the 8th day.

Other factors 207 can also affect the user's score. These factors can be adjusted (added or removed) by the network administrators to ensure fairness of the scores generated. These factors can include, but are not limited to the following: the user's cash balance, the user's credit balance, location, credit rating, answering a survey, complaints filed by other users, and user feedback ratings. These factors are considered based on statistical analysis of network data, user feedback, or the network policies.

Additionally, in accordance with the present application, the score can be assigned to an entity denoting a physical location. The location entity can establish one or more data-points that represents an accumulation and/or flow of users that spend at a network-affiliated merchant located at the given address. The value of the location entity rises as user traffic and spending increases, thereby creating more demand for the property or real estate. Examples include a home goods store located in a shopping center or a fast food restaurant located on a city street.

The collection, organization, and calculation of spending activity at a location can provide a method to measure and rank the value of a property using or in association with a score. The property score can be comprised of spending activity of one or more users associated with the property, the user(s)' referral network, and/or financial activity of the merchant at the location. This results in insight into the business ecosystem, hence more accurate scores and appropriate rewards.

### II. How a User is Rewarded

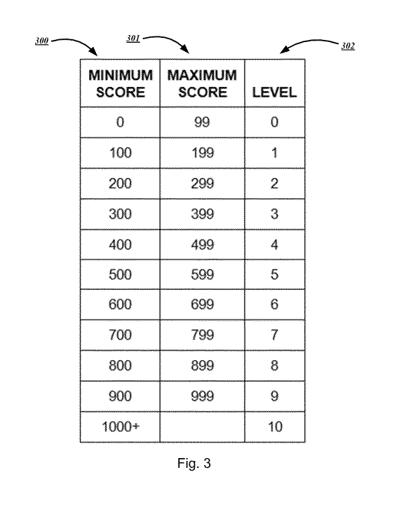

In one or more implementations, a reward provided to a user in the network is determined using a score associated with the user. Moreover, the amount of reward, type of reward or the way the reward is administered can be changed based on type of user, source of reward, location of the user, other users related to the user, time of reward, or the user's score. To ease reward distribution, users can be categorized into levels based on their scores. FIG. 3 provides an example of a score level categorization. In one or more embodiments of the present application, levels can be categorized by name (e.g. silver, gold, VIP, etc.). Referring to the example shown in FIG. 3, each respective level 302 has a minimum and maximum point score. The minimum point score can be the fewest number of points a user has to accumulate before they qualify for that level 300.

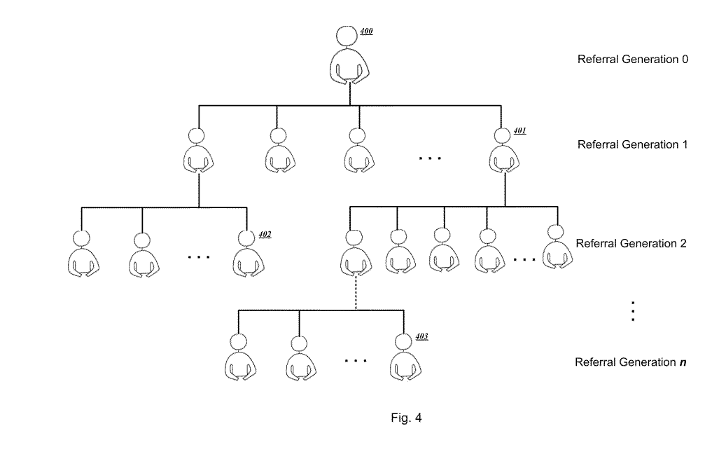

First, the system monitors or otherwise determines user referrals based on relationships within the network. With reference to the example in FIG. 4, other users can be related to a user 400 through a direct referral relationship (such as for a user who has been invited to join the data communication network of the present application) 401. Alternatively, users can be related in accordance with an indirect referral relationship, such as a user who was directly invited by a user to join the network (e.g., a “generation 1 user”) invites one or more other users to join the data communication network of the present application (e.g., a “generation 2 user”) 402, 403. Any users beyond referral generation 1 are considered to have an indirect-referral relationship with a user.

The following paragraphs detail a non-exhaustive list of examples of implementations of the present application for rewarding users of a data communication network.

### Referral Network Commissions

A user can be rewarded or can become eligible for a reward when they invite a friend/contact (invitee) to join the network and their invitee agrees to the request. This invitee is considered the referral; the user who invited the referral is considered the direct referrer. In addition, if the referral also signs up their friend/contact, then the referral becomes a direct referrer of the new referral (also called the “child” of the member who referred him/her), and the initial inviting user who invited this direct referrer becomes an indirect referrer (also referred to as the “parent” of the member he referred). Indirect referrers can also be rewarded for the activities, influence, and spending of indirect referrals. The rewards can be set to stop at n generations deep of the referral network (where n may be any number, e.g., 4) as detailed in the example in FIG. 4. Rewards can be in monetary or non-monetary form.

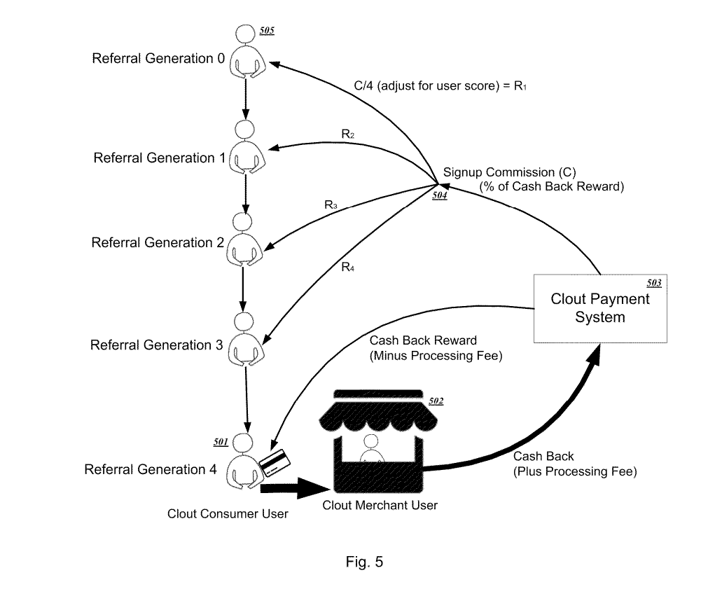

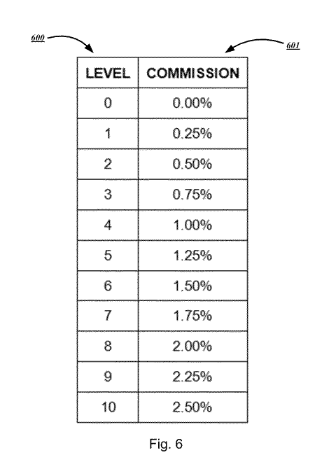

For example, with reference to FIG. 5, when a direct referral or indirect referral 501 makes a purchase at a network-affiliated merchant 502, the direct referrer and n generations of parents of the direct referrer may be entitled to receive a commission. One example of a reward that may occur in the system is a cash back reward. This reward can be triggered when a referral makes a purchase at a network-affiliated merchant offering a cash back reward to system users who make a qualified purchase that matches a criteria set by the merchant. Upon distribution of the cash back reward to the user, the referrers may be entitled to collect a percentage of the cash back distribution (or other form of reward). The payout C 504 can be tied to and commensurate with each user's system score. For example, using a reward distribution scheme as shown in the example in FIG. 6, a referrer with a score of 650 points (level 6) would receive 1.50% of the cash back that the system collects from the merchant with respect to the transaction by the referral.

If the rewards relationship is set to 4 generations deep from the buying user, then the direct referrer, his parent, the grandparent, and the great grandparent would each be eligible to earn a reward when such referral user makes a purchase. For example, if the cash back reward from the merchant is 10% and the referral purchase is $100, then the cash back reward amount would equal $10. Further, if each of the 4 eligible referrers have scores of 320, 430, 670, and 980, then based on the example shown in FIG. 6, the referrers will be entitled to commissions equal to 0.75%, 1%, 1.50%, and 2.25% of the cash back reward, respectively, and the payout to each referrer would equal to $0.075, $0.10, $0.15, and $0.225, respectively. The reward component of the system is designed to be flexible such that any monetary or non-monetary reward (such as a modification of any term and/or condition) can be substituted as in the example above, with the ability to increase the value (or perceived value) of such reward as the referrer's score increases, and such that a reward can be issued for any measurable activity.

### Cash Back Rewards

A user can receive direct cash back from a qualifying transaction if a merchant user is offering a cash back reward or cash back discount on the transaction and the user paid using a device or financial institution account recognized in the system and linked to their user account. The cash back can also be adjusted based on the user score with a higher score leading to a higher cash back reward. The cash back amount offered to users can be controlled and adjusted by the merchant user and can be set to increase or decrease in value based on the score level of the user with that merchant.

### Merchant Sponsored Offers

In one or more embodiments of the present application, merchant users can offer direct monetary or non-monetary rewards to qualifying consumer users for purchases or activities with their business. These can include free/bonus products or services, special sales, special experiences, VIP treatment/admittance, and special upgrades/perks. These offers can also be commensurate with the user score to attract users with a higher spending capability/influence. For example, a promotion “free court-side ticket for Lakers vs. Nuggets on Dec. 15, 2014 for the first 10 purchases this Saturday” may be offered to members who are level 8 and above. In another example, a promotion like “80% off Men's suits for the 3 users who have the highest in-store spending score and who check in publicly to our store this Sunday—Limit 3” may be offered to users of all levels for indirect marketing by a merchant user.

### III. The Clout Score

The Clout Score is a number assigned to an individual to reflect one or more of their overall profile, influence, spending, activity, loyalty and ability compared to all other individuals in the network. This score can be related to the following:

1) The attributes (data-points) of the individual that may be relevant in determining their online and offline influence, for example: whether the user's social network account is connected; whether the user's email is verified; whether the user's mobile phone is verified; whether the user has a valid profile photo; whether there is an active bank account linked to the user's account; the user's financial transactions, the value and makeup of a user's assets, the user's available cash balance; and the user's available credit balance.

2) The individual's activities and his relation to other users' activities on the system as well as off the system (where an activity can be tracked and is relevant to the system), for example: whether the user processed their first payment using the system; whether the user made a public check-in in the last 7 days; whether the user answered a survey in the system in the last 30 days; the number of direct referrals signed up versus other users in the last 180 days; and the amount the user spent through the system versus other users in the last 30 days.

3) The activities of other individual users in relation to the user on and off the system, for example: spending of your direct referrals versus spending of other member's direct referrals for the last 180 days; and lifetime spending of your network referrals versus lifetime spending of other member's network referrals (in this case “lifetime” refers to the period since the user joined the system or as far back as their data available to the system goes, whichever is longer).

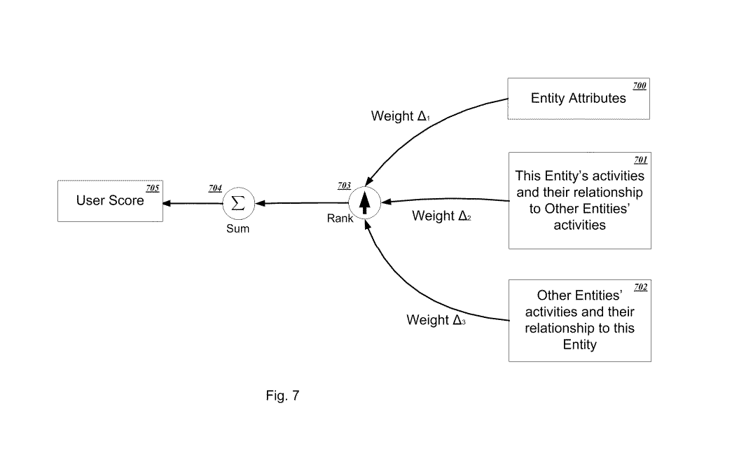

This data from the above criteria can be used to generate the user score as depicted in the example in FIG. 7. Weighting can be done by applying a minimum and maximum score to normalize the resulting value. The final value can be determined from preset scoring formulae which may be scalable or ON/OFF depending on the input data-point values and business rule requirements. Referring to the example in FIG. 7, a rank 703 can be applied to the weighted values in relation to other users before they are added up 704 for all data points under consideration to determine the user's score 705.

Additional implementations of the present application are now discussed.

Below is a simplified example to demonstrate the process of generating a score:

### 1. Identify Data Points:

USER 1: Joey is a college student and an active system user who consistently refers friends but spends relatively little money at network-affiliated merchants compared to other network members. 1) Has connected a social network? YES. 2) How many referred friends eventually signed up? 130. 3) How much was spent on in-store purchases in the last 30 days? $55.

USER 2: Bob is a big spender (most likely a high net-worth individual) with few friends. He therefore does not actively refer his colleagues to the system. 1) Has connected a social network? NO. 2) How many referred friends eventually signed up? 8. 3) How much was spent on in-store purchases in the last 30 days? $1,600.

USER 3: Anna is a very active user and an active referrer of her friends to the network. She also makes it a point to shop at network-affiliated merchants following her budget for the month. 1) Has connected a social network? YES. 2) How many referred friends eventually signed up? 300. 3) How much was spent on in-store purchases in the last 30 days? $500.

### 2. Weight, Rank and Sum the Data Points:

### Ranking

Using the following weighting criteria: has the user connected to the social network? [YES: 50, NO: 0]; how many referred friends eventually signed up? [100×Rank]; and how much was spent on in-store purchases in the last 30 days? [200×Rank].

The rank is computed from:

$$\frac{{c}_{𝓁} + 0.5 {f}_{i}}{N} \times 100 \%$$

where cₗ is the count of all scores less than the score of interest, fᵢ is the frequency of the value of interest (if it exceeds 1), and N is the number of examinees in the sample.

From the above criteria, the users have the following weighted points used to compute the total points T: USER 1: (50+50+0)=100 points=T₁; USER 2: (0+0+200)=200 points=T₂; and USER 3: (50+100+100)=250 points=T₃.

### Weighted Average

Using the following weighting criteria: has the user connected to the social network? [YES: 5, NO: 0]; how many referred friends eventually signed up? [1×normalized number of friends]; and how much was spent on in-store purchases in the last 30 days? [2×normalized amount].

The total points are computed from:

$${\overline{x}}_{w} = \frac{{\sum }_{i = 1}^{n} ( {w}_{i} \cdot {x}_{i} )}{{\sum }_{i = 1}^{n} ( {w}_{i} )}$$

where x_{w} is the weighted mean variable, wₜ is the allocated weighted value, and xₜ is the value of the data point.

From the above criteria, the users have the following total points: USER 1: (5+130×1+55×2)/(5+1+2)=245/8=31 points=T₁; USER 2: (0+8×1+1600×2)/(5+1+2)=3208/8=401 points=T₂; and USER 3: (5+300×1+500×2)/(5+1+2)=1305/8=163 points=T₃.

### Measuring Activity

Using the following weighting criteria: has the user connected to the social network? [YES: 5, NO: 0]; how many referred friends eventually signed up? [normalized number of friends]; and how much was spent on in-store purchases in the last 30 days? [normalized amount].

The rank is computed from:

$$T = {a}_{0} + {\sum }_{n = 0}^{n} {x}_{n}$$

where T is the total number of points, a₀ is the initial number of points each user starts with, n is the number of entities in the sample, and xₙ is the normalized value of the data-point.

From the above criteria, the users have the following total points T, assuming the initial number of points, a₀ for each user is 50: USER 1: 50+(5+130+5.5)=191 points=T₁; USER 2: 50+(0+8+160)=218 points=T₂; and USER 3: 50+(5+300+50)=405 points=T₃.

### Assigning Value to Presence, Absence, or Frequency of Electronic Information

Using the following weighting criteria: 1) has the user connected to the social network? [YES: 5, NO: −2]; 2) how many referred friends eventually signed up? [1×normalized number of friends]; 3) how much was spent on in-store purchases in the last 30 days? [2×normalized amount]; 4) is the user a college student? [YES: 2, NO: 0]; and 5) is the user an active referrer (more than 100 referred signups in the last 30 days)? [YES: 1, NO: −1].

The rank is computed from:

$$T = {\sum }_{n = 0}^{n} {V}_{n}$$

where T is the total number of points, n is the number of entities in the sample, and Vₙ is the value assigned to the presence, absence or frequency of the data point.

From the above criteria, the users have the following total points T: USER 1: (5+130×1+5.5×2+2+1)=149 points=T₁; USER 2: (−2+8×1+160×2+0+−1)=325 points=T₂; and USER 3: (5+300×1+50×2+0+1)=406 points=T₃.

### Independent Data Points

Using the following weighting criteria: 1) has the user connected to the social network? [YES: 5, NO: 0]; 2) how many referred friends eventually signed up? [normalized number of friends]; and 3) how much was spent on in-store purchases in the last 30 days? [normalized amount].

The rank is computed from:

$$T = {\sum }_{x = 0}^{n} f ( x ) {V}_{x}$$

where T is the total number of points, f(x) is the initial number of points each user starts with, n is the number of entities in the sample, and Vₓ is the normalized value of the data point.

From the above criteria, the users have the following total points T, assuming the values of f(x) are f(x₁)=2^{x}, f(x₂)=log(x), and f(x₃)=1.5x: USER 1: 2⁵+log(130)+1.5×5.5=(32+2+8)=42 points=T₁; USER 2: 2⁰+log(8)+1.5×160=(1+1+240)=242 points=T₂; and USER 3: 2⁵+log(300)+1.5×50=(32+2+75)=109 points=T₃.

3. Assign a Score to the User Based on their Total Points

Assigning a score to the user can be done by application of a normalization factor Ω to the total points T obtained by the user through the scoring process. The normalization factor can be set by the system administrator and may be changeable by the system. The score S can be obtained by the following formula: S=ΩT.

For example, applying the above formula to the score obtained with the “Ranking” approach using a normalization factor of 1 gives a score as follows: USER 1: S=1×100=100; USER 2: S=1×200=200; and USER 3: S=1×250=250.

The score can then be stored, displayed or transmitted as and when needed. This approach can be used in the generation of all the scores (e.g., Clout Score, Store Score, Merchant Score and Location Score). The only difference is the data points under consideration for each score type as well as the corresponding weights attached to these data points.

### IV. The Store Score

The Store Score is a number assigned to an individual to reflect their influence, spending activity, ability, and loyalty at a given store (merchant user premises or point of sale). This “store” can be a physical location or virtual presence, such as an e-commerce website. The user's influence at a store can be determined by considering the following.

1) The user's attributes and activities in the system which could affect a merchant user's interest in them, such as: available cash balance; average cash balance over a period (e.g., last 180 days), available credit balance; average credit balance over a period (e.g., last 180 days); credit rating; and presence of good behavior and/or misbehavior tags associated with the user in the system.

2) Previous activities with the merchant, for example: total in-store spending in the last 90 days versus total spending of other users at the same store; whether the user answered a store survey in previous 30 days; whether the user responded to a store advertisement in the previous 180 days; total promotions for the merchant by the user in the system; total responses by other users to the user's promotions of the store; and total check-ins at the merchant's store in the last 90 days.

3) Activities at the merchant's competitors or other businesses of interest to the merchant user, for example: total spending with direct competitors in the last 90 days; total spending at stores in merchant's industry category/related categories; total check-ins at the merchant's competitors; and total surveys taken at the merchant's competitors.

The approach to computing the Store Score and Merchant Score is similar to that of the Clout score depicted in FIG. 7 with the difference being the data-points under consideration for each user. Every user in the system can obtain a clout score for every merchant user registered with the system. The user Store Scores are important to merchants in that they can easily gauge influence and capacity of their customers (other users) which translates to more targeted offerings and customer loyalty. The store owners can prepare their promotions to attract those with low scores at their store, reward loyalty or both.

### V. The Merchant Score

Merchants can also be assigned a score to determine their credibility and influence of in the system. This score can be an indicative number that other merchants and even individual users may view when dealing with the merchant in question, or which can be used jointly or solely by the system. Merchants with a high Merchant Score can receive non-public offerings and special consideration in the system due to their high influence. For example, a merchant with a high Merchant Score may receive a discount on paid advertisement in the system or a discount on processing fees.

To raise their Merchant Score, stores should watch 1) the store's attributes (profile data-points) on the system, such as: whether the merchant's bank account is verified; whether the merchant's profile is complete; whether the merchant accepts cash back discounts; and whether the merchant has network-related promotions running in their store; 2) the store's activities on the system, for example: whether the merchant processed their first payment in the system; whether the merchant ran a promotion in the system; whether the merchant has positive and/or negative behavioral flags (e.g., not honoring their offers, late payment of cash back, misuse of system messaging facilities, violation of network terms of use); and the number of referrals the merchant has attracted to the system versus other network-affiliated merchants (in the store's industry category/zip code/region/whole Clout system); and 3) the user's activities at the store, such as: the amount users have spent at the store compared to other stores (in the store's industry category/zip code/region/whole system); the number of user check-ins that occurred at the store in the last 90 days in relation to other stores (in the store's industry category/zip code/region/whole system); and complaints from users about the store.

Merchants may have access to non-identifying customer data to help them setup their account and promotions for their target audience upon joining the system. Fees may apply for one or more services accessed by merchants in the system. Additionally, as described herein, a high Merchant Score can result in the merchant user receiving special offerings with features including but not limited to: discounted or free services, extra functions not available to other merchants (such as drill down of target audience data and more views of reports), or relaxed protocols (such as non-verification of their mobile phone push promotions).

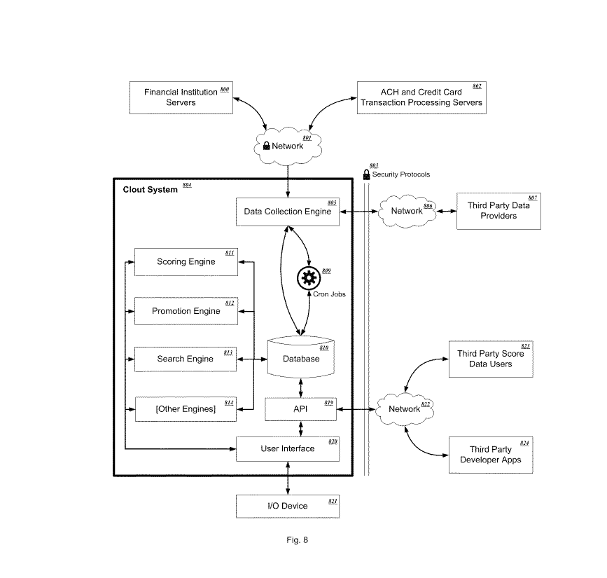

In one or more embodiments of the present application, and as shown in the example in FIG. 8, the Clout system 804 can be set up to include a computer network that may not be in one physical location—the “cloud”. Data used for the system can be obtained from the users or potential users, third-party data providers 807, and financial institutions 800. All data from non-secured sources passes the system security protocols and checks to be approved for use in the system. Some data may require the user to provide additional confirmation to be obtained from the third-party sources while other data may be scraped, purchased, or obtained by the system without the user's participation.

Data obtained from all sources can be collected, filtered, organized, formatted, and packaged for storage, search, processing, use, and display by a Data Collection engine 805, which works with the assistance of cron jobs 809 to perform its functions. For example, sources of data collection for all transactions with user activities on the system can be packaged for system processing that contain completed profiles, additions of other users to the referral network, tracking of bank spending histories, bank account activity, store purchases, redeemed promos, and other entities.

The clean and sorted data can be used by other engines of the system such as a search engine 813, promotion engine 812 and scoring engine 811, among others, to carry out user and system required tasks supporting the user interface features and system operations. In combination, the system parts create an intelligent “brain” that can track user relationships and is able to perform autonomous tasks in response to the discovered relationships. Such tasks can include updating their score, providing relevant information to a user (e.g., helpful tips), introducing/suggesting a relationship of a user to another user with whom there is a high degree of connection (e.g., a customer who always shops for similar items near a network-affiliated store with a high Store Score), and blocking or adding access rights to a user based on their record and activity in the system.

The user interface 820 is accessible using a variety of input/output (I/O) devices 821 including but not limited to laptops, desktops, mobile phones, tablets, wearable devices, store point of sale equipment, and specialized display equipment (e.g., auto infotainment systems and in-store marketing displays).

To extend the benefits of the user scores as well as other relevant data and statistics generated by the system, verified and approved third-party data users 823 and developer apps 824 can have access to this information through an Application Interface (API) 819 with pre-specified and well documented access and security protocols.

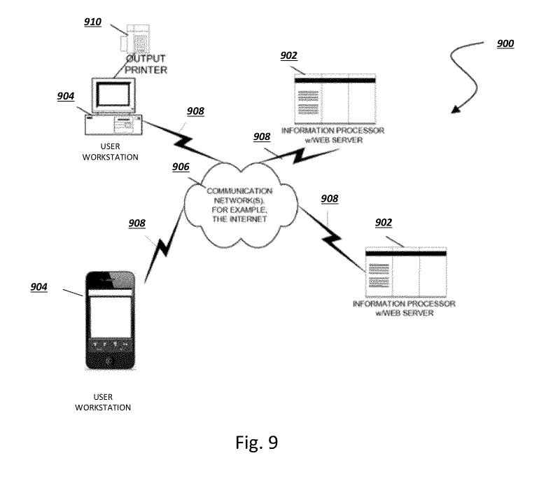

Referring to FIG. 9 a diagram is provided of an example hardware arrangement that operates for providing the systems and methods disclosed herein, and designated generally as system 900. System 900 is preferably comprised of one or more information processors 902 coupled to one or more user workstations 904 across communication network 906. User workstations may include, for example, mobile computing devices such as tablet computing devices, smartphones, wearable devices, personal digital assistants or the like. Further, printed output is provided, for example, via output printers 910.

Information processor 902 preferably includes all necessary databases for the present invention, including image files, metadata and other information. However, it is contemplated that information processor 902 can access any required databases via communication network 906 or any other communication network to which information processor 902 has access. Information processor 902 can communicate to devices as well as databases using any known communication method, including a direct serial, parallel, USB interface, or via a local or wide area network.

User workstations 904 communicate with information processors 902 using data connections 908, which are respectively coupled to communication network 106. Communication network 906 can be any communication network, but is typically the Internet or some other global computer network. Data connections 908 can be any known arrangement for accessing communication network 906, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User workstations 904 preferably have the ability to send and receive data across communication network 906, and are equipped with web browsers to display the received data on display devices incorporated therewith. By way of example, user workstation 904 may be personal computers such as Intel Pentium-class computers or Apple Macintosh computers, but are not limited to such computers. Other workstations which can communicate over a global computer network such as palmtop computers, smart phones, wearable devices (like Google Glass or smart watches), personal digital assistants (PDAs) and mass-marketed Internet access devices such as WebTV can be used. In addition, the hardware arrangement of the present invention is not limited to devices that are physically wired to communication network 906. Of course, one skilled in the art will recognize that wireless devices can communicate with information processors 902 using wireless data communication connections (e.g., WIFI or BLUETOOTH) or through imbedded devices, biometric devices (e.g. bio-imbedded chips, fingerprint scans, and retina scans).

According to an embodiment of the present application, user workstation 904 provides user access to information processor 902 for the purpose of receiving and providing art-related information. The specific functionality provided by system 900, and in particular information processors 902, is described in detail below.

System 900 preferably includes software that provides functionality described in greater detail herein, and preferably resides on one or more information processors 902 and/or user workstations 904. One of the functions performed by information processor 902 is that of operating as a web server and/or a web site host. Information processors 902 typically communicate with communication network 906 across a permanent i.e., unswitched data connection 908. Permanent connectivity ensures that access to information processors 902 is always available.

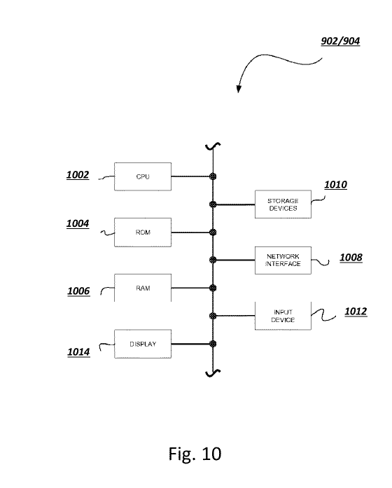

As shown in FIG. 10 the functional elements of each information processor 902 or workstation 904, and preferably include one or more central processing units (CPU) 1002 used to execute software code in order to control the operation of information processor 902, read only memory (ROM) 1004, random access memory (RAM) 1006, one or more network interfaces 1008 to transmit and receive data to and from other computing devices across a communication network, storage devices 1010 such as a hard disk drive, floppy disk drive, tape drive, CD-ROM or DVD drive for storing program code, databases and application code, one or more input devices 1012 such as a keyboard, mouse, track ball and the like, and a display 1014.

The various components of information processor 902 need not be physically contained within the same chassis or even located in a single location. For example, as explained above with respect to databases which can reside on a storage device 1010, this storage device 1010 may be located at a site which is remote from the remaining elements of information processors 902, and may even be connected to CPU 1002 across a communication network 106 via a network interface 1008.

The functional elements shown in FIG. 10 (designated by reference numbers 1002-1014) are preferably the same categories of functional elements preferably present in a user workstation 904. However, not all elements need be present, for example, storage devices in the case of PDAs, and the capacities of the various elements are arranged to accommodate expected user demand. For example, CPU 1002 in user workstation 904 may be of a smaller capacity than CPU 1002 as present in information processor 902. Similarly, it is likely that information processor 902 will include storage devices 1010 of a much higher capacity than storage devices 1010 present in work station 904. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, PHP, JAVASCRIPT, OBJECTIVE-C, JAVA, ACTIVEX, HTML, XML, ASP, SOAP, IOS, ANDROID, TORR, SQL, ORACLE and various web application development environments.

As used herein, references to displaying data on a user workstation 904 refer to the process of communicating data to the workstation across a communication network 906 and processing the data such that the data can be viewed on the user workstation 904 display 1014 using a web browser, Graphic User Interface (GUI) or the like. The display screens on user workstation 904 present areas within control allocation system 900 such that a user can proceed from area to area within the control allocation system 900 by selecting a desired link. Therefore, each user's experience with control allocation system 900 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 900.

Although the present application may be shown and described by way of example herein in terms of a web-based system using web browsers and a web site server (information processor 902), and with mobile computing devices (904) system 900 is not limited to that particular configuration. It is contemplated that control allocation system 900 can be arranged such that user workstation 904 can communicate with, and display data received from, information processor 902 using any known communication and display method, for example, using a non-Internet browser Windows viewer coupled with a local area network protocol such as the Internetwork Packet Exchange (IPX). It is further contemplated that any suitable operating system can be used on user workstation 904, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, LINUX, IOS, iPHONE, ANDROID and any suitable PDA or palm computer operating system.

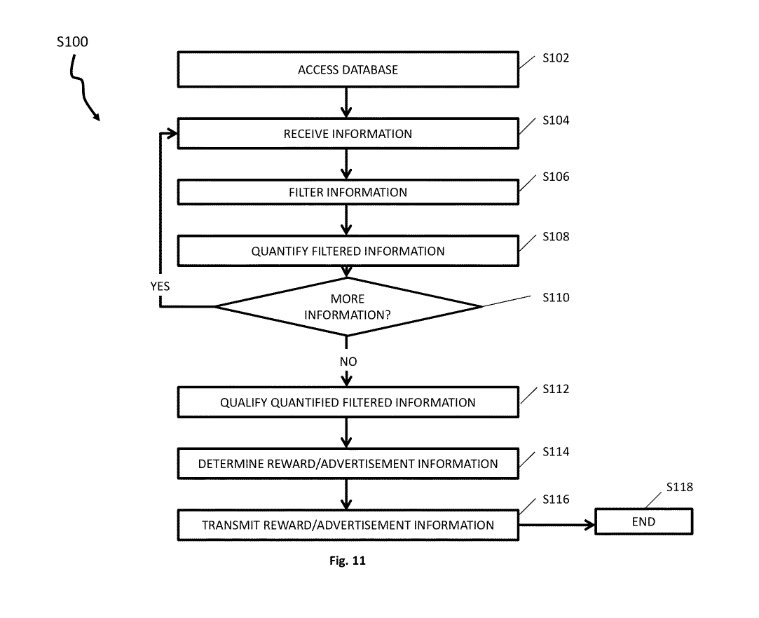

FIG. 11 is a flowchart illustrating steps S100 associated with an example implementation of the present application. At step S102, the process begins and at least one database that includes electronic entity information, electronic filter information and electronic weighting information is accessed by at least one processor. Information is received that is associated with a first of the plurality of entities (step S104). The information that is received in step S104 is filtered, for example using the at least one processor in accordance with the electronic filtering information (step S106). The filtered information is, thereafter, quantified in accordance with the electronic weighting information from the at least one database (step S108). Thereafter, a determination is made whether additional information is received using the at least one processor (step S110). If so, then the process loops back to step S104 and additional information is received. If not, then the process continues and all of the quantified and filtered information up to that point is qualified using the at least one processor (step S112). Thereafter, determination is made using the at least one processor whether at least one reward or advertisement is to be provided to at least one of the first and second entities in accordance with the qualifying step S112 (step S114). Information associated with the reward is, thereafter, transmitted (step S116). The process ends at step S118.

In addition to the features and implementations shown and described herein, various forms of functionality are provided by the present patent application. For example, a relationship between entities can be suggested, such as introducing a customer to a business. Additionally, a user or entity may be blocked from accessing the system for various reasons, such as when the user violates the terms of use of the system. An entity or user's access permissions and/or features can also be modified or adjusted in a similar fashion. In another example, an entity's scoring or weighting of one or more of its data points can be modified based on one or more factors, such as changes in the user's activity. Further, a new data point may be generated for consideration in the scoring for an entity, a particular category of entities, or all entities. Non-obvious information about an entity or category of entities classified based on a preset data point (e.g., statistics about login attempts, devices used to access the system by a given a category of users) can also be generated and/or transmitted by the system. Additionally, notifications regarding a change in an entity's profile or activity can be generated and/or transmitted by the system, for example reporting suspicious purchases of an entity to the administrator to prevent fraudulent activity in the system. In yet another example, the activities and/or profile of an entity may be automatically promoted to other entities, for instance marketing new merchants to users in a particular geographical area.

Although one or more of the implementations described herein may be in respect to financial transactions and marketing approaches, the implementations may be applied to other types of networks where an accurate estimate of the influence, value, and spending ability of an entity in a network of entities needs to be obtained.

In view of the structure, functions, and features of the systems and methods of the network described herein, the present solution provides a dynamic, efficient, and more accurate way to compute, obtain, store, and distribute an estimate of the influence, value, and spending ability of an entity in a network of entities. Having described certain embodiments of methods and systems for setting up such a network, it will now become apparent to one of skill in the art that other embodiments incorporating the concepts of the disclosure may be used. Accordingly, the foregoing disclosure, description, and drawing figures are for illustrative purposes only.

What is claimed:

1. A method, comprising,
accessing, by at least one processor, at least one database that includes:
electronic entity information including information associated with each of a plurality of respective entities;
electronic filter information representing at least one parameter for filtering information in accordance with relevance of information;
electronic weighting information representing at least one parameter usable for quantifying filtered information;
receiving, using the at least one processor over a data communication network, first electronic information associated with a first of the respective entities;
filtering, using the at least one processor, at least some of the first electronic information in accordance with the electronic filtering information;
quantifying, using the at least one processor, the filtered first electronic information in accordance with the electronic weighting information;
receiving, using the at least one processor over the data communication network, second electronic information associated with a second of the respective entities;
filtering, using the at least one processor, at least some of the second electronic information in accordance with the electronic filtering information;
quantifying, using the at least one processor, the filtered second electronic information in accordance with the electronic weighting information;
qualifying, using the at least one processor, the quantified filtered first and second electronic information; and
determining, using the at least one processor, at least one reward and/or advertisement to be provided to at least one of the first and second entities in accordance with the qualifying; and
transmitting, by the at least one processor, information associated with the at least one reward and/or advertisement to at least one computing device.

2. The method of claim 1, further comprising categorizing, using the at least one processor, the filtered first and second electronic information in accordance with at least one of improving data quality and/or data access, standard industrial classification code, and geographic location.

3. The method of claim 1, wherein the relevance of information includes at least one of completed profiles, referring new entities, bank spending, account activity, store purchases, promotion redemption, amount of information, age of information, accuracy of information, and ease of obtaining information, and
further wherein the electronic information is associated with at least one of referring new entities, spending activity, responding to surveys, providing identification and location information, verifying entity information, and use of devices to connect to the data communication network.

4. The method of claim 1, further comprising tracking, using the at least one processor, activity associated with at least one of the first and second entities, wherein the tracked activity includes at least one of entity login, purchases, financial information, opt-in for promotions, survey completions, location, and providing contact information.

5. The method of claim 1, wherein the electronic information includes a plurality of data points, and quantifying the filtered first and second electronic information includes quantifying each of the respective data points.

6. The method of claim 1, further comprising determining, using the at least one processor, a price or the terms or conditions of advertising, products, services, or compensation applicable to at least one entity in accordance with at least one of the electronic information, quantified information, qualification, and score of an entity.

7. The method of claim 1, wherein the qualifying includes, using the at least one processor:
ranking the first and second entities;
applying a respective score to at least one of the first and second entities; and/or
increasing or decreasing at least one of the quantified filtered first and second electronic information.

8. The method of claim 1, wherein the qualifying includes using the quantified filtered first and second electronic information and/or using at least one of the received first and second electronic information.

9. The method of claim 1, wherein the qualifying includes ranking the first and second entities by respectively calculating:
$$\frac{{c}_{𝓁} + 0.5 {f}_{i}}{N} \times 100 \%$$
where cₗ is the count of all scores less than the score of interest, fᵢ is the frequency of the value of interest (if exceeds 1), and N is the number of entities in the sample.

10. The method of claim 1, wherein the qualifying includes determining a weighted average by calculating:
$${\overline{x}}_{w} = \frac{{\sum }_{i = 1}^{n} ( {w}_{i} \cdot {x}_{i} )}{{\sum }_{i = 1}^{n} ( {w}_{i} )}$$
where x_{w} is the weighted mean variable, wₜ is the allocated weighted value, and xₜ is the value of the data point.

11. The method of claim 1, wherein the qualifying includes measuring activity by calculating:
$$T = {a}_{0} + {\sum }_{n = 0}^{n} {x}_{n}$$
where T is the total number of points, a₀ is the initial number of points each user starts with, n is the number of entities in the sample, and xₙ is the normalized value of the data-point.

12. The method of claim 1, wherein the qualifying includes assigning value to one or more of the presence, absence, or frequency of electronic information by calculating:
$$T = {\sum }_{x = 0}^{N} {V}_{n}$$
where T is the total number of points, N is the number of entities in the sample, and Vₓ is the value assigned to the presence, absence, or frequency of the data point.

13. The method of claim 1, wherein the qualifying includes determining independent data points by calculating:
$$T = {\sum }_{x = 0}^{n} f ( x ) {V}_{x}$$
where T is the total number of points, f(x) is the initial number of points each user starts with, n is the number of entities in the sample, and Vₓ is the normalized value of the data point.

14. The method of claim 1, wherein quantifying the filtered first and second electronic information comprises assigning a score for activity associated with a plurality of entities, and assigning at least one score for a respective entity, and normalizing at least one of the scores, wherein at least one of the scores is calculated by:
S=ΩT
where Ω is a normalization factor and T represents total points.

15. The method of claim 1, wherein at least one of the quantified filtered first and second electronic information is represented as a score.

16. The method of claim 15, wherein at least one score is one or more of a system score, a store score, a merchant score and a location score.

17. The method of claim 16, wherein the store score represents at least one of an entity's influence, spending activity, ability, and loyalty at a given store, and further wherein the merchant score represents at least one of a credibility and influence of at least one merchant.

18. The method of claim 15, wherein the score is recalculated and subject to change over time.

19. The method of claim 15, wherein the score is adjusted in response to one or more of:
particular activity of an entity;
time decay;
changes in weight associated with a respective data point;
upper and/or lower limits; and
at least one trend.

20. The method of claim 15, wherein the score is provided to at least one third party.

21. The method of claim 1, wherein the at least one reward and/or advertisement is provided by at least one of the respective entities.

22. The method of claim 1, wherein the nature and/or amount of the at least one reward and/or advertisement is determined by at least one of the respective entities.

23. The method of claim 1, wherein the at least one reward and/or advertisement is for promoting an entity in the data communication network.

24. The method of claim 1, wherein the at least one reward and/or advertisement is associated with activities outside of the data communication network.

25. The method of claim 1, further comprising adjusting, using the at least one processor, at least one of:
at least one of the first and second received electronic information;
at least some of the electronic filtering information;
at least some of the electronic weighting information;
the quantifying; and
the qualifying,
in accordance with activity based on at least one trend, an applied score, and at least one activity of at least one other of the plurality of entities.

26. The method of claim 1, further comprising determining a type of at least one of:
the at least one reward and/or advertisement
a value and/or attribute of the at least one reward and/or advertisement;
and how the at least one reward and/or advertisement is delivered,
in accordance with at least one of:
electronic information;
ranking;
score;
quantified information;
financial transactions;
a location of at least one of the first entity and the second entity;
a time when the at least one reward and/or advertisement is given;
at least one direct referral; and
at least one indirect referral.

27. The method of claim 1, wherein the qualifying is further performed in accordance with one or more attributes of one or more of the respective entities, wherein the attributes include cash, credit, asset balance, financial transactions, an entity's location and duration of an entity that is associated with the data communication network.

28. The method of claim 1, further comprising changing the qualifying of at least one of the quantified filtered first and second electronic information in response to activity of one or more other of the respective entities.

29. The method of claim 1, further comprising:
receiving, using the at least one processor over the data communication network, third electronic information associated with a third of the respective entities;
filtering, using the at least one processor, at least some of the third electronic information in accordance with the electronic filtering information;
quantifying, using the at least one processor, the filtered third electronic information in accordance with the electronic weighting information, and wherein the
qualifying, using the at least one processor, the quantified filtered first, second and third electronic information; and
determining, using the at least one processor, at least one reward and/or advertisement to be provided to at least one of the first, second and third entities in accordance with the qualifying; and transmitting, by the at least one processor, information associated with the at least one reward and/or advertisement to at least one computing device.

30. A system comprising:
at least one database that is accessible using at least one processor, and that includes:
electronic entity information including information associated with each of a plurality of respective entities;
electronic filter information representing at least one parameter for filtering information in accordance with relevance of information;
electronic weighting information representing at least one parameter usable for quantifying filtered information;
a data receiving module that receives, using the at least one processor over a data communication network, first electronic information associated with a first of the respective entities and second electronic information associated with a second of the respective entities;
a filtering module that filters, using the at least one processor, at least some of the first electronic information and at least some of the second electronic information in accordance with the electronic filtering information;
a weighting module that quantifies, using the at least one processor, the filtered first electronic information and the filtered second electronic information in accordance with the electronic weighting information;
a qualifying module that qualifies, using the at least one processor, the quantified filtered first electronic information and quantified filtered second electronic information; and
a rewards and advertising module that determines, using the at least one processor, at least one reward and/or advertisement to at least one of the first and second entities in accordance with the qualifying, and transmits information associated with the at least one reward and/or advertisement to at least one computing device.

31. The system of claim 30, further comprising a predictive module that predicts, using the at least one processor, relationships between the entities based on developing patterns by an entity or between entities.

32. The system of claim 30, wherein at least one of the first and second entities authorize access to electronic information stored at a third-party system.

33. The system of claim 30, wherein at least one of the first entity and the second entity provides at least some of the electronic weighting information.

34. The system of claim 30, wherein at least some of the received information is modified by at least one of:
the at least one processor;
the first entity; and
the second entity.

35. The system of claim 30, wherein the at least one processor, a network administrator or at least one of the respective entities modifies at least some of the electronic weighting information.

36. The system of claim 30, wherein at least some of the first and second electronic information includes at least one of referring new entities, financial activity, responding to surveys, providing identification and location information, verifying entity information, in-store spending, online spending, competitor spending, spending by a user at other businesses of a product or service, related category spending, overall spending, cash balance, credit balance, asset value, activity, responsiveness, and entering or connecting electronic information to the network.

37. The system of claim 30, further comprising a location module that assigns, using at least one processor, respective scores to a plurality of locations or addresses of entity activities in accordance with data-points collected over a time period;
wherein the ranking the locations is in accordance with the respective locations' scores in relation to other locations proportionate to the activities of entities at the locations or addresses.

38. The system of claim 30, further comprising a management module that determines respective scores associated with at least one of the respective entities in accordance with data points collected over a period of time.

39. The system of claim 30, wherein the at least one processor is further configured, based on at least at least one of: entity behavior, statistics and trends, to:
propose a relationship between at least two of the respective entities;
prevent an entity from joining the data communication network;
modify the quantifying or the qualifying;
generate new information associated with quantifying the filtered first and/or second electronic information, a category of at least one other of the plurality of entities;
modify access permissions for at least one of the plurality of entities;
notify at least one other entity of a change in an entity's profile or activity; and
promote an entity's activities.
